(19) United States
(12) Patent Application Publication
(10) Pub. No.: US 2022/0179468 A1
(43) Pub. Date: Jun. 9, 2022

(54) POWER SUPPLIES TO VARIABLE PERFORMANCE ELECTRONIC COMPONENTS

(71) Applicant: Hewlett-Packard Development Company, L.P., Spring, TX (US)

(72) Inventors: Chao-Wen Cheng, Taipei City (TW); Chien-Fa Huang, Taipei City (TW); Roger A. Pearson, Fort Collins, CO (US); Chung Yu Chang, Taipei City (TW)

(73) Assignee: Hewlett-Packard Development Company, L.P., Spring, TX (US)

(21) Appl. No.: 17/598,359

(22) PCT Filed: Jul. 25, 2019
(86) PCT No.: PCT/US2019/043529

§ 371 Date: Sep. 27, 2021

(51) Int. Cl. G06F 1/26; G06F 1/18

(52) U.S. Cl. CPC G06F 1/263; G06F 1/189

(57) ABSTRACT

In examples, a computer system comprises a first power supply having first and second power rails; a second power supply having a third power rail; a motherboard coupled to the first power rail; a central processing unit (CPU) coupled to the second power rail; a variable performance electronic component coupled to the third power rail; and a controller coupled to enable inputs of the first and second power supplies.

BACKGROUND

An electronic device, such as a computer, is powered by a power supply. The power supply provides power to the computer—for example, to the system motherboard, which then distributes the power to various electronic components of the computer. Power supplies of varying power outputs are available and are generally selected based on the power consumption of the components within the computer. For instance, a 500 watt power supply may be housed within a computer and used to supply power to, e.g., a central processing unit and a graphics processor.

### BRIEF DESCRIPTION OF THE DRAWINGS

Various examples will be described below referring to the following figures:

FIG. 1 is a block diagram of a computer system with an illustrative computer power supply system, in accordance with various examples.

FIG. 2 is a block diagram of a computer system with an illustrative computer power supply system, in accordance with various examples.

FIG. 3 is a block diagram of a computer system with an illustrative computer power supply system, in accordance with various examples.

FIG. 4 is a block diagram of a computer system with an illustrative computer power supply system, in accordance with various examples.

FIG. 5 is a block diagram of a computer system with an illustrative computer power supply system, in accordance with various examples.

FIG. 6 is a block diagram of a motherboard controller, in accordance with various examples.

FIG. 7 is a front view of a power supply access bracket with one orifice, in accordance with various examples.

FIG. 8 is a front view of a power supply access bracket with two orifices, in accordance with various examples.

FIG. 9 is a cross-sectional profile view of a computer system implementing an illustrative computer power supply system and a power supply access bracket, in accordance with various examples.

### DETAILED DESCRIPTION

Computers are often powered with a single, high wattage power supply. In some cases, the intended use of the computer does not necessitate such high power output, and the user is thus directing financial capital toward resources that will be underutilized or unused. It addition, a single power supply outputs a limited number of power rails, and thus the flexibility with which its power is distributed may be limited. For example, in some cases, a graphics processor in the computer may have periods of increased power consumption due to increased performance, but the limited number of rails provided by the single power supply prevents the graphics processor from receiving a boost in power when needed. These and other challenges are common to computers with single power supplies. Furthermore, few computer chassis designs are properly equipped to handle multiple power supplies.

This disclosure describes solutions to the foregoing challenges in the form of a novel computer power supply system (CPSS) deployed in a computer system. The CPSS includes multiple (e.g., two) power supplies. (The multiple power supplies may have lower power outputs than the traditional single power supply with a high power output, e.g., two 250 W supplies rather than a single 500 W supply.) A first power supply in the CPSS provides multiple (e.g., two or three) power rails, and a second power supply in the CPSS also provides multiple (e.g., two or three) power rails. Using two power supplies with four rails provides a level of flexibility of power distribution that is not available with a single power supply having fewer rails. (In some examples, more than two power supplies are used, but the majority of this discussion assumes the use of two power supplies, each power supply having two rails.)

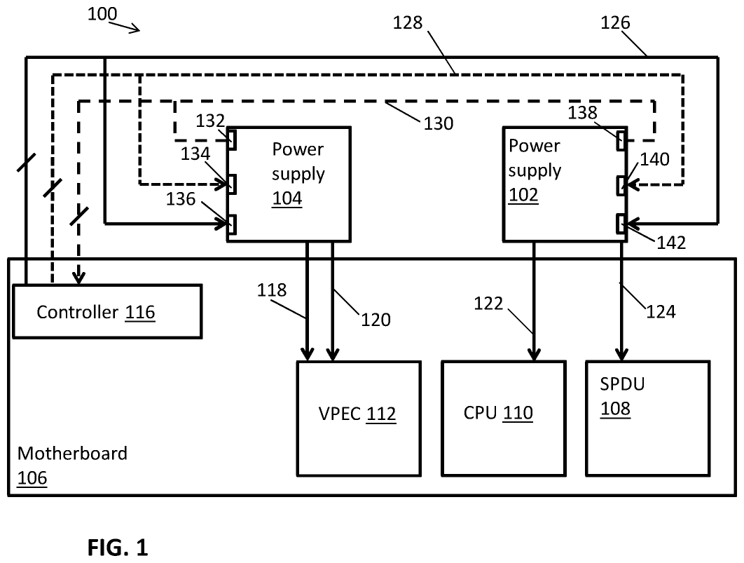

Various configurations of power supplies and power rails are contemplated and are described below with respect to FIGS. 1-6. In one example, a first rail of a first power supply couples to and powers the system motherboard, and a second rail of the first power supply couples to and powers the central processing unit (CPU). A first rail of a second power supply also couples to and powers the CPU, and a second rail of the second power supply couples to and powers a variable performance electronic component (VPEC), such as a graphics processor. A VPEC is an electronic component in a computer system having a range of performance levels, with greater performance levels demanding greater power consumption and lesser performance levels demanding lesser power consumption. The system motherboard couples to the CPU and graphics processor. The system motherboard is to provide a first amount of power to the VPEC such that the VPEC is able to perform its basic functions. This first amount of power is dedicated to the VPEC. In addition, the power provided to the VPEC by the fourth power rail is also dedicated to the VPEC. Thus, when the performance (and, thus, power consumption) of the VPEC increases, the power provided by the fourth power rail is sufficient to meet the increased power draw of the VPEC. This type of power distribution configuration enables the VPEC to properly perform at a higher level with increased power consumption. The two power supplies in the novel CPSS may be approximately the same size as a larger, single power supply. Thus, no changes to the size or shape of the computer system chassis are needed.

The two power supplies in the novel CPSS are simultaneously powered on and off by a controller in the CPSS. The controller also provides to the power supplies a pulse width modulated (PWM) signal to control the fans of the power supplies in an appropriate manner to prevent overheating. In addition, the controller receives status signals from the power supplies indicating proper function of the power supplies. If improper power supply function is detected, the controller may issue an alert signal, thus prompting users to take suitable remedial action.

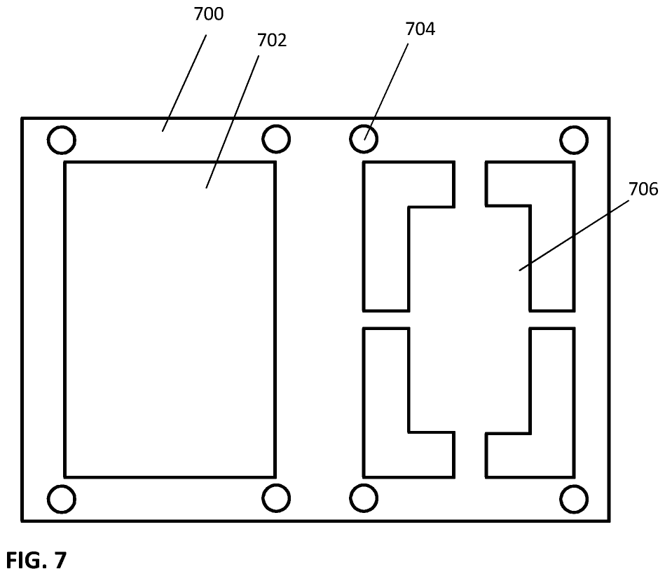

This disclosure also describes a two-plate power supply access bracket with a knock-out feature. A “knock-out” feature is a design that facilitates the easy and quick removal of plates from the bracket, for example, by striking or pushing the plate with sufficient force. An example bracket with a knock-out feature is described below in tandem with FIG. 7. The bracket is positioned adjacent to the rear panel of the computer chassis such that each of the two plates aligns with a different one of the two power supplies. The plates may be knocked out (removed) to enable mains power (wall) access to the power supplies via the bracket. In case one power supply is installed in the computer chassis, the corresponding plate is knocked out. In case two power supplies are installed in the computer chassis, both corresponding plates are knocked out. In cases where both plates are knocked out to facilitate access to two power supplies, a single alternating current (AC) dongle may be used to couple both power supplies to mains power.

In some examples, the computer chassis includes protrusions (e.g., hooks) to prevent unintended movement of the power supplies within the chassis.

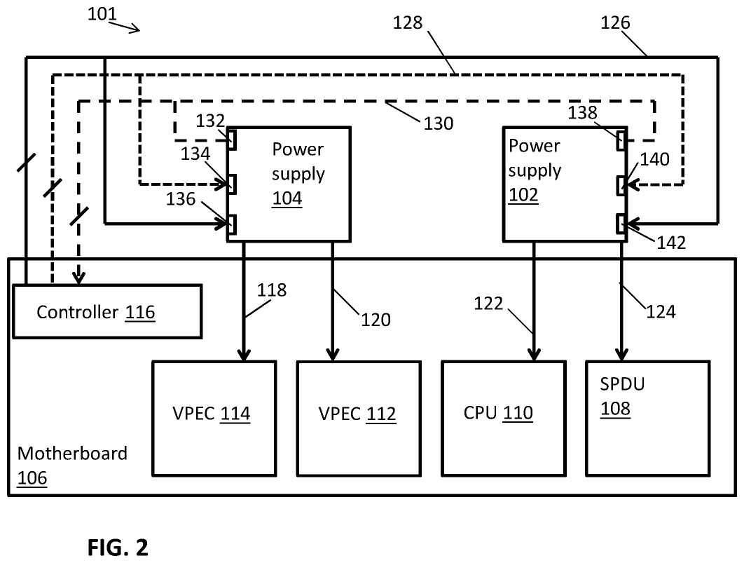

FIG. 1 is a block diagram of a computer system 100 with an illustrative CPSS, in accordance with various examples. The computer system 100 comprises a motherboard 106. Positioned on the motherboard 106 are a system power distribution unit (SPDU) 108, a CPU 110, a VPEC 112 (e.g., a graphics processor), and a controller 116. The SPDU 108 is part of the motherboard 106 and comprises any suitable logic, processor(s), and/or executable code needed to manage the distribution of power to components on the motherboard 106. For example, the SPDU 108 may distribute power to the CPU 110, the VPEC 112, and any other components needing power that may be present on the motherboard 106. For instance, additional CPUs and/or VPECs may be present on the motherboard 106 (e.g., as shown in FIGS. 2-4 and 6), in which case the SPDU 108 may distribute power to some or all of these additional CPUs and/or VPECs. In some examples, the SPDU 108 provides a generally constant power supply to the CPU 110, VPEC 112, and any other CPUs and/or VPECs on the motherboard 108. For instance, in some examples, the SPDU 108 may provide a minimum, fixed operating power needed by such components to function at a certain performance level (e.g., a lowest performance level).

The computer system 100 further includes a power supply 102 and a power supply 104. Although two power supplies are shown, any number of power supplies may be provided. The power supply 102 provides multiple power rails. For example, the power supply 102 provides power rails 122, 124. The power supply 104 also provides multiple power rails, for example, power rails 118, 120. In the particular configuration shown in FIG. 1, the power rail 118 couples to and powers the VPEC 112; the power rail 120 also couples to and powers the VPEC 112; the power rail 122 couples to and powers the CPU 110; and the power rail 124 couples to and powers the SPDU 108. In some examples, each of the power rails 118, 120, 122, and 124 provides 12 V, although other voltages are contemplated. In some examples, as may be the case with any of the examples described below, the power rails 118, 120, 122, and 124 are electrically independent of each other and are not coupled to each other. In some examples, the power supply 102 is a 250 W power supply. In some examples, the power supply 102 is a 300 W power supply. In some examples, the power supply 104 is a 250 W power supply. In some examples, the power supply 104 is a 300 W power supply. In some examples, the power supply 104 is a 400 W power supply. Other output power capabilities are contemplated.

The power supply 102 includes multiple control inputs. In some examples, the power supply 102 comprises a power supply enable input 142. In some examples, the power supply 102 comprises a fan enable input 140. In some examples, the power supply 102 includes an output, such as a power supply status output 138. Likewise, the power supply 104 includes multiple control inputs. In some examples, the power supply 104 comprises a power supply enable input 136. In some examples, the power supply 104 comprises a fan enable input 134. In some examples, the power supply 104 includes an output, such as a power supply status output 132. The inputs and outputs of the power supplies 102, 104 are coupled to the controller 116. Specifically, the controller 116 couples to a connection 126, which couples to power supply enable inputs 142, 136. In addition, the controller 116 couples to a connection 128, which couples to fan enable inputs 140, 134. Further, the controller 116 couples to a connection 130, which couples to power supply status outputs 138, 132. The power supplies 102, 104, the power rails 118, 120, 122, 124, and the connections 126, 128, 130 may collectively be referred to as the CPSS.

In an example operation, the controller 116 simultaneously enables the power supplies 102, 104 via the power supply enable inputs 142, 136, respectively. Once the power supplies 102, 104 are enabled, the power supplies 102, 104 begin supplying power to the SPDU 108, the CPU 110, and the VPEC 112. The amount of power supplied depends on the output power capabilities of the power supplies 102, 104. In some examples, the power supply 102 is a 250 W power supply, and the power supply 104 is a 250 W power supply. In this configuration, the power supply 102 may supply, e.g., 125 W on the power rail 122 and the remaining 125 W on the power rail 124. In addition, the power supply 104 may supply, e.g., 125 W on the power rail 118 and 125 W on the power rail 120. In this manner, the power supply 104 provides 250 W to the VPEC 112, the power supply 102 provides 125 W to the CPU 110, and the power supply 102 provides 125 W to the system power 108. The SPDU 108 may provide a minimum amount of power to the VPEC 112 needed for the VPEC 112 to operate at a predetermined performance level (e.g., a lowest performance level), such as 75 W. However, at times, the VPEC 112 may boost its performance and thus its power consumption, and the 250 W supplied by the power supply 104 is available to the VPEC 112 to support such increased power consumption needs.

During operation, the controller 116 provides PWM signals to the fan enable inputs 134, 140 to cool the power supplies 104, 102, respectively. The PWM signals may be modulated in any suitable manner to provide appropriate cooling for the power supplies 102, 104. The power supplies 102, 104 return status signals to the controller 116 via the power supply status outputs 138, 132, respectively. If a status signal indicates unacceptable performance, the controller 116 may take precautionary measures, for example, issuing an alert signal (e.g., an alarm) so that a user may take remedial action. The controller 116 may disable the power supplies 102, 104 simultaneously via the power supply enable inputs 142, 136.

FIG. 2 is a block diagram of a computer system 101 with another illustrative CPSS, in accordance with various examples. The CPSS of FIG. 2 is comparable to that of FIG. 1, with the exception that the motherboard 106 includes a VPEC 114. The VPEC 114 couples to the power supply 104 via the power rail 118, and the VPEC 112 couples to the power supply 104 via the power rail 120. The operation of the computer system 101 is comparable to that of the computer system 100, with the exception that the power supply 104 supplies a portion of its power to the VPEC 112 and a portion of its power to the VPEC 114. In some examples, the power supply 104 is a 300 W power supply with 150 W provided to the VPEC 112 and 150 W provided to the VPEC 114. In some examples, the power supply 102 is a 250 W power supply with power distribution on its power rails comparable to that described with respect to FIG. 1. The VPECs 112, 114 are provided with a fixed power supply from the SPDU 108, and when either or both of the VPECs 112, 114 increases its performance and thus its power consumption, it uses the additional power supplied via the power rails 120, 118.

Still referring to FIG. 2, in some examples, the power supply 102 is a 300 W power supply and the power supply 104 is a 300 W power supply. In such examples, the power supply 104 may provide 150 W on power rail 118 and 150 W on power rail 120. The power supply 102 may provide 150 W on each of the power rails 122, 124.

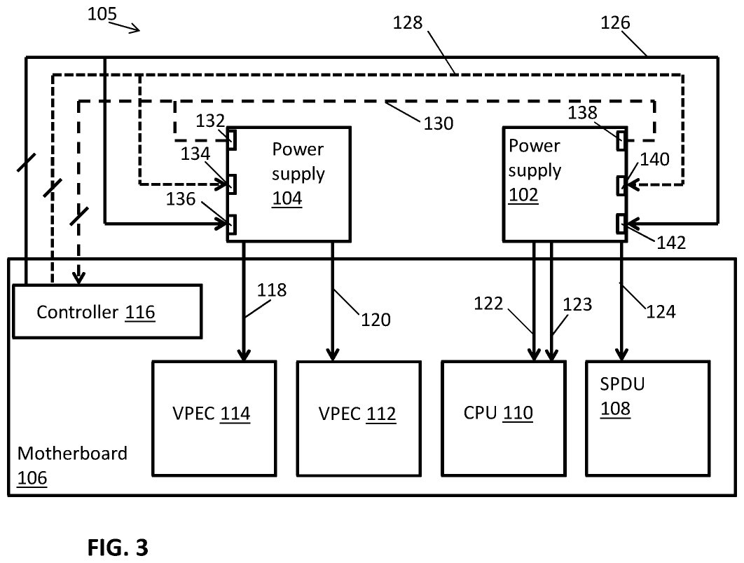

FIG. 3 is a block diagram of a computer system 105 with yet another illustrative CPSS, in accordance with various examples. The CPSS of FIG. 3 is comparable to that of FIG. 2, with the exception that the power supply 102 outputs power on three power rails 122, 123, 124 instead of two power rails. The power rails 122, 123 couple to the power supply 102 and to the CPU 110. The power rail 124 couples to the power supply 102 and to the SPDU 108. The operation of the computer system 105 is comparable to that of computer system 101, with the exception of power provided to the CPU 110 via the power rails 122, 123. In some examples, the power supply 102 is a 250 W power supply providing 83.3 W on each of the power rails 122, 123, 124. Other power distributions may be applied on the power rails 122, 123, 124. In some examples, the power supply 104 is a 400 W power supply providing 200 W on each of the power rails 118, 120. Other power distributions may be applied on the rails 118, 120.

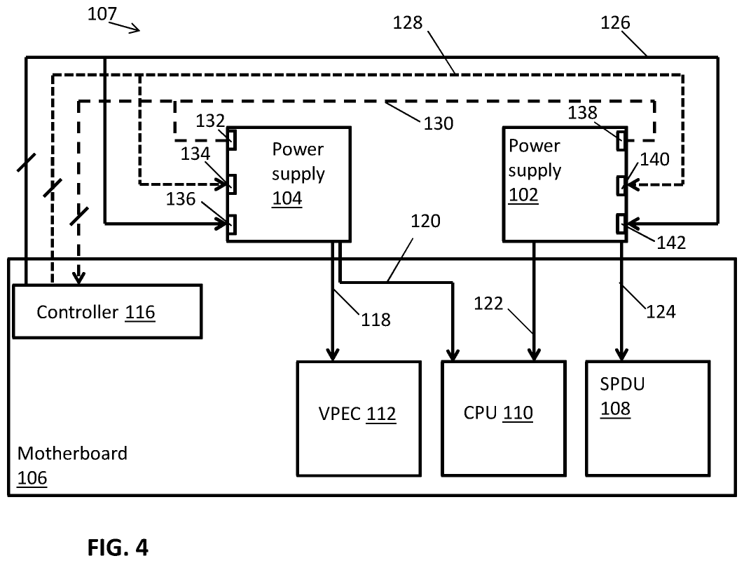

FIG. 4 is a block diagram of a computer system 107 with yet another illustrative CPSS, in accordance with various examples. The CPSS of FIG. 4 is comparable to that of FIG. 1, with the exception that two power rails are coupled to the CPU 110 instead of to the VPEC 112. In particular, the power supply 102 couples to the SPDU 108 via power rail 124 and to the CPU 110 via the power rail 122. In addition, the power supply 104 couples to the CPU 110 via the power rail 120 and to the VPEC 112 via the power rail 118. In some examples, the power supply 102 is a 250 W power supply and the power supply 104 is a 250 W power supply. In some such examples, the power supply 102 provides 125 W on each of the power rails 122, 124, and the power supply 104 provides 125 W on each of the power rails 118, 120. The operation of the computer system 107 is otherwise comparable to the operation of the computer system 100 of FIG. 1.

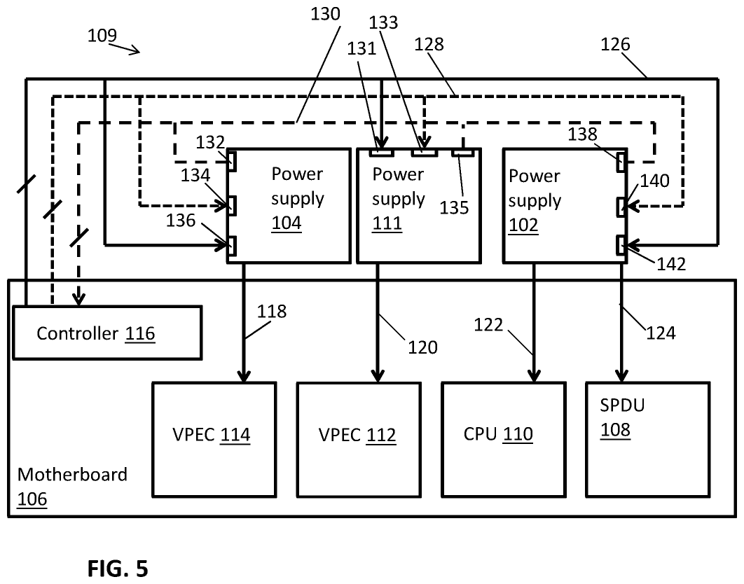

FIG. 5 is a block diagram of a computer system 109 with yet another illustrative CPSS, in accordance with various examples. The CPSS of FIG. 5 is similar to that of FIG. 2, with the exception that the CPSS of FIG. 5 includes a power supply 111 in addition to the power supplies 102, 104. The power supply 111 includes a power supply enable input 131 coupled to the controller 116 via connection 126. The power supply 111 also includes a fan enable input 133 coupled to the controller 116 via connection 128. The power supply 111 further includes a power supply status output 135 that couples to the controller 116 via connection 130. The power supply 111 couples to the VPEC 112 via the power rail 120. The power supply 104 couples to the VPEC 114 via the power rail 118. The power supply 102 couples to the CPU 110 via the power rail 122, and the power supply 102 couples to the SPDU 108 via the power rail 124. In some examples, each of the power supplies 102, 104, 111 is a 250 W power supply. In some such examples, the power supply 102 outputs 125 W on the power rail 122 and 125 Won the power rail 124. In some such examples, the power supply 104 outputs 250 W on the power rail 118. In some such examples, the power supply 111 outputs 250 W on the power rail 120. The remainder of the operation of the computer system 109 is comparable to that of the computer system 101 of FIG. 2, described above.

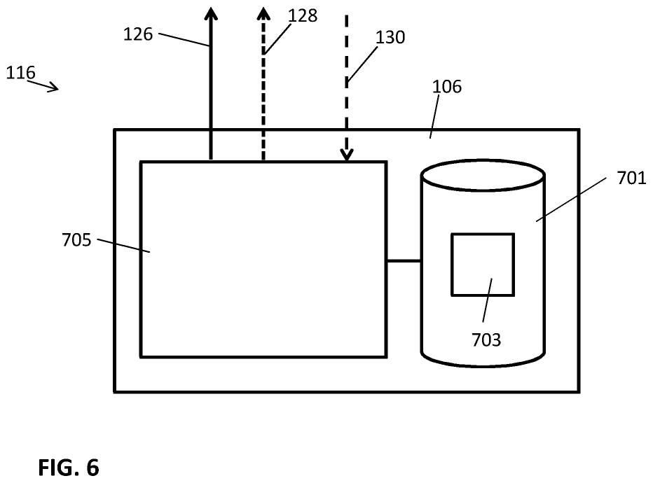

FIG. 6 is a block diagram of the controller 116, in accordance with various examples. The controller 116 includes a memory 701 storing executable code 703. The memory 701 couples to a processor 705. The processor 705 executes the executable code 703, which causes the processor 705 to perform some or all of the actions attributed herein to the controller 116. In addition, the processor 705 receives the connection 130 and outputs the connections 126, 128. The processor 705 reacts to signals received on the connection 130 and provides signals on the connections 126, 128 based on the instructions in the executable code 703 and as described above.

FIG. 7 is a front view of a power supply access bracket 700, in accordance with various examples. The bracket 700 includes an orifice 702 and a plate 706. The plate 706 is removable, or may be “knocked out,” to create another orifice similar to the orifice 702. The orifice 702 may previously have had a similar plate in its place that may have been knocked out to produce the orifice 702. The bracket 700 further comprises a plurality of orifices 704 to fasten the bracket 700 to another component, such as a computer system chassis, using screws or other fastening devices. The bracket 700 may be installed on a rear panel of a computer system chassis such that the orifice 702 is aligned with a single power supply housed within the computer system chassis. The bracket 700, and more particularly the orifice 702, facilitates easy connection between mains power and the power supply.

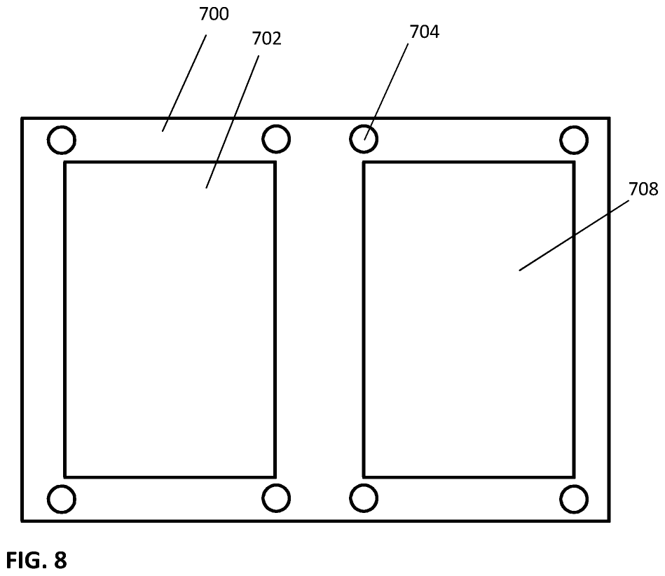

FIG. 8 is another front view of the power supply access bracket 700, in accordance with various examples. The bracket 700 as depicted in FIG. 8 is identical to the bracket 700 as depicted in FIG. 7 except that the bracket 700 of FIG. 8 no longer includes the plate 706, which has been knocked out. Instead, an orifice 708 is included in place of the plate 706. The bracket 700 as depicted in FIG. 8 is thus useful in computer system chassis housing two power supplies. In such a chassis, the bracket 700 may be mounted on a rear panel of the chassis such that the orifice 702 aligns with a first power supply and the orifice 708 aligns with a second power supply. In this manner, the bracket 700 provides easy access between mains power and the power supplies.

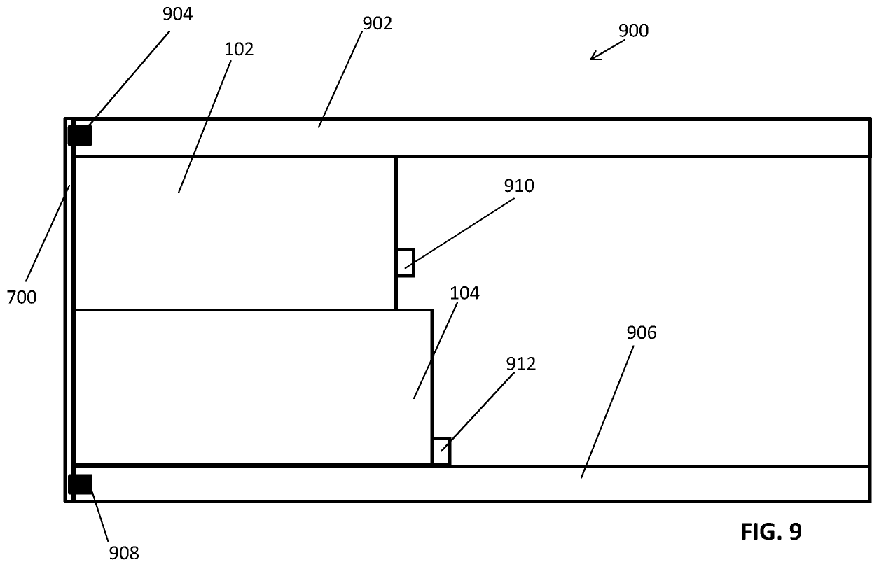

FIG. 9 is a cross-sectional profile view of a computer system 900 implementing an illustrative CPSS and the power supply access bracket 700, in accordance with various examples. The computer system 900 includes a chassis having top and bottom members 902 and 906. Power supplies 102, 104 are housed within the chassis of the computer system 900. The bracket 700 is aligned with the power supplies 102, 104 such that the appropriate orifices of the bracket 700 are aligned with the power supplies 102, 104. The bracket 700 may be fastened to the top and bottom members 902, 906 using fasteners 904, 908, respectively. The computer system 900 also comprises protrusions 910, 912 that couple to the chassis and that provide mechanical support to the power supplies 102, 104 so that the power supplies 102, 104 do not slide or move within the chassis of the computer system 900. In some examples, each of the protrusions 910, 912 is approximately 2 centimeters in length, 1 centimeter in width, and 1 centimeter in height, although other dimensions are contemplated and fall within the scope of disclosure. The computer system 900 may include more than the two fasteners depicted in FIG. 9.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A computer system, comprising:
a first power supply having first and second power rails;
a second power supply having a third power rail;
a motherboard coupled to the first power rail;
a central processing unit (CPU) coupled to the second power rail;
a variable performance electronic component coupled to the third power rail; and
a controller coupled to enable inputs of the first and second power supplies.

2. The system of claim 1, wherein the controller is to simultaneously enable the first and second power supplies and to simultaneously disable the first and second power supplies.

3. The system of claim 1, wherein the second power supply has a fourth power rail, and wherein the fourth power rail couples to the variable performance electronic component.

4. The system of claim 1, wherein the second power supply has a fourth power rail, and wherein the fourth power rail couples to another variable performance electronic component.

5. The system of claim 4, wherein the first power supply has a fifth power rail, and wherein the fifth power rail couples to the CPU.

6. The system of claim 1, wherein the second power supply has a fourth power rail, the fourth power rail coupled to the CPU.

7. The system of claim 1, comprising a third power supply having a fourth power rail, wherein the fourth power rail couples to another variable performance electronic component.

8. The system of claim 1, wherein the first, second, third, and fourth power rails are to provide a same voltage output.

9. The system of claim 1, comprising a power supply access bracket, the first power supply aligned with a first orifice of the power supply access bracket and the second power supply aligned with a second orifice of the power supply access bracket.

10. The system of claim 1, comprising a chassis housing the first power supply, the chassis comprising a protrusion extending from a surface of the chassis, the protrusion in physical contact with the first power supply.

11. A computer system, comprising:
a motherboard;
a central processing unit (CPU) coupled to the motherboard;
a variable performance electronic component coupled to the motherboard;
a first power supply to provide first power to the motherboard via a first power rail and to the CPU via a second power rail, the motherboard to provide at least some of the first power to the variable performance electronic component;
a second power supply to provide second power to the variable performance electronic component via a third power rail; and
a controller coupled to the first and second power supplies, the controller to simultaneously enable the first and second power supplies and to simultaneously disable the first and second power supplies.

12. The system of claim 11, wherein the third power rail is dedicated to the variable performance electronic component.

13. The system of claim 11, wherein the first, second, and third power rails are to carry a same voltage, and wherein the first, second, and third power rails are not coupled to each other.

14. A computer system, comprising:
a chassis;
first and second power supplies housed within the chassis, the first power supply having first and second power rails coupled to a motherboard and a central processing unit (CPU), respectively, and the second power supply having a third power rail coupled to a variable performance electronic component;
a power supply access bracket coupled to the chassis, a first orifice of the power supply access bracket aligned with the first power supply and a second orifice of the power supply access bracket aligned with the second power supply;
a first protrusion inside the chassis in physical contact with the first power supply; and
a second protrusion inside the chassis, the second protrusion in physical contact with the second power supply.

15. The system of claim 14, comprising a controller to enable the first and second power supplies at the same time and to disable the first and second power supplies at the same time.
